(19) United States
(12) Patent Application Publication
(10) Pub. No.: US 2010/0284559 A1
(43) Pub. Date: Nov. 11, 2010

(54) UNDER-CHIN HEADPHONE SET

(75) Inventors: Joachim Scholz, Hambuhren (DE); Christoph Greger, Delligsen (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Sennheiser electronic GmbH & Co., KG, Wedemark (DE)

(21) Appl. No.: 12/738,286

(22) PCT Filed: Oct. 17, 2008
(86) PCT No.: PCT/EP08/08818

§ 371 Date: Jul. 7, 2010

(30) Foreign Application Priority Data
Oct. 17, 2007 (DE) 10 2007 050 043.4

(51) Int. Cl. H04R 25/00

(52) U.S. Cl. 381/374

(57) ABSTRACT

There is provided an under-chin band headphone set comprising two earpiece bands (OB) and two earplugs (OS) which are respectively secured to an ear-side end (OB1) of the two earpiece bands (OB). A respective ball joint (K) is provided at the ear-side end (OB1) of the earpiece bands (OB) in such a way that a first end of the ball joint (K) is arranged movably at the ear-side end (OB1) of the earpiece band (OB) and the second end of the ball joint (K) serves to receive the earplugs (OS).

The present invention concerns an under-chin band headphone set.

Under-chin band headphone sets typically comprise a housing, two earpiece bands and two plugs which can be inserted into the ears of a user. The weight of the under-chin band headphone set is thus held only by the earplugs in the outer ear of a user. When the under-chin band headphone set is being worn the housing of the under-chin band headphone set is typically on the chest or in front of the neck of a user.

DE 84 10 574 U1 discloses an under-chin band headphone set in which an earpiece band is arranged rotatably on a housing.

DE 699 12 289 T2 discloses a headphone with a sound-focusing passage for sealing against an edge of an auditory canal. The passage can be afforded by means of a ball joint.

DE 102 08 331 A1 discloses a binaurally rotatable headphone capsule.

DE 196 35 888 A1 discloses a multi-passage stereophonic sound small-scale headphone set. A headphone set capsule-headphone set band joint can be in the form of a ball joint.

The object of the present invention is to provide an improved under-chin band headphone set.

That object is attained by an under-chin band headphone set as set forth in claim 1.

Therefore there is provided an under-chin band headphone set comprising two earpiece bands and two earplugs which are respectively secured to an ear-side end of the two earpiece bands. A respective ball joint is provided at the ear-side end of the earpiece bands in such a way that a first end of the ball joint is arranged movably at the ear-side end of the earpiece band and the second end of the ball joint serves to receive the earplugs.

In accordance with an aspect of the invention the first end of the ball joint is of a spherical configuration and is secured by means of latching hooks at the ear-side end of the earpiece band.

In accordance with a further aspect of the invention provided at a first end of the ball joint is a plurality of holes or recesses which can co-operate with the latching hooks to hold the ball joint.

In accordance with a further aspect of the present invention a belt clip can be secured to a rear side of a housing of the under-chin band headphone set.

The invention also concerns an under-chin band headphone set comprising two earpiece bands and two earplugs which are respectively secured to an ear-side end of the two earpiece bands. The under-chin band headphone set further has a housing for receiving at least one electronic unit. The ends, remote from the ears, of the earpiece bands are secured rotatably to the housing.

Further configurations of the invention are subject-matter of the appendant claims.

Advantages and embodiments by way of example of the invention are described in greater detail hereinafter with reference to the drawing.

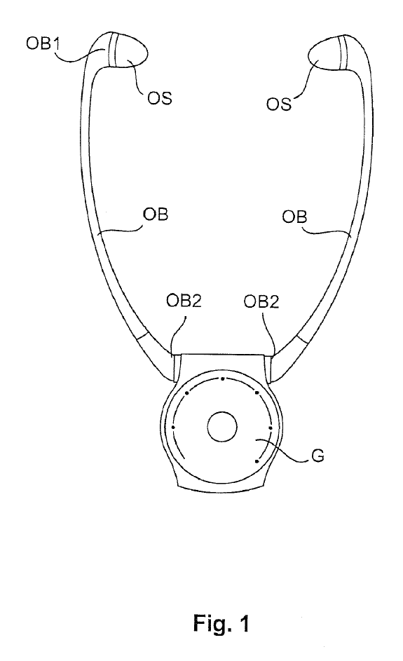

FIG. 1 shows a diagrammatic view of an under-chin band headphone set according to a first embodiment,

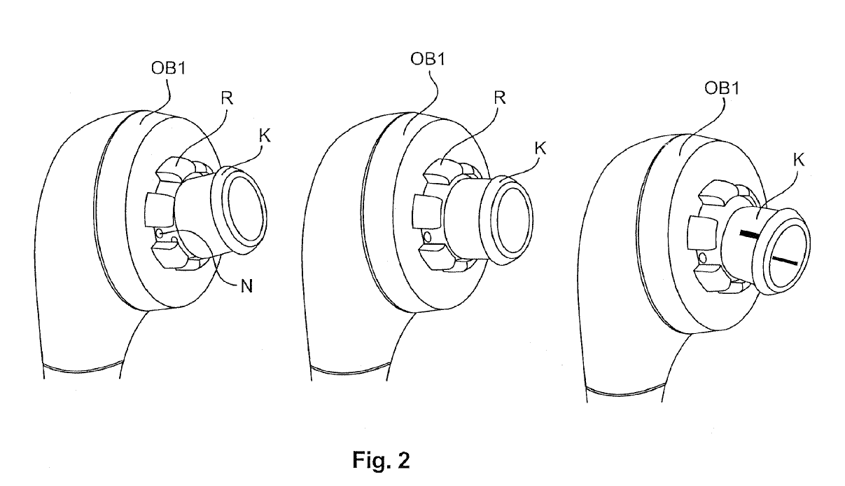

FIG. 2 shows a diagrammatic view of an ear-side end of the earpiece bands according to the first embodiment,

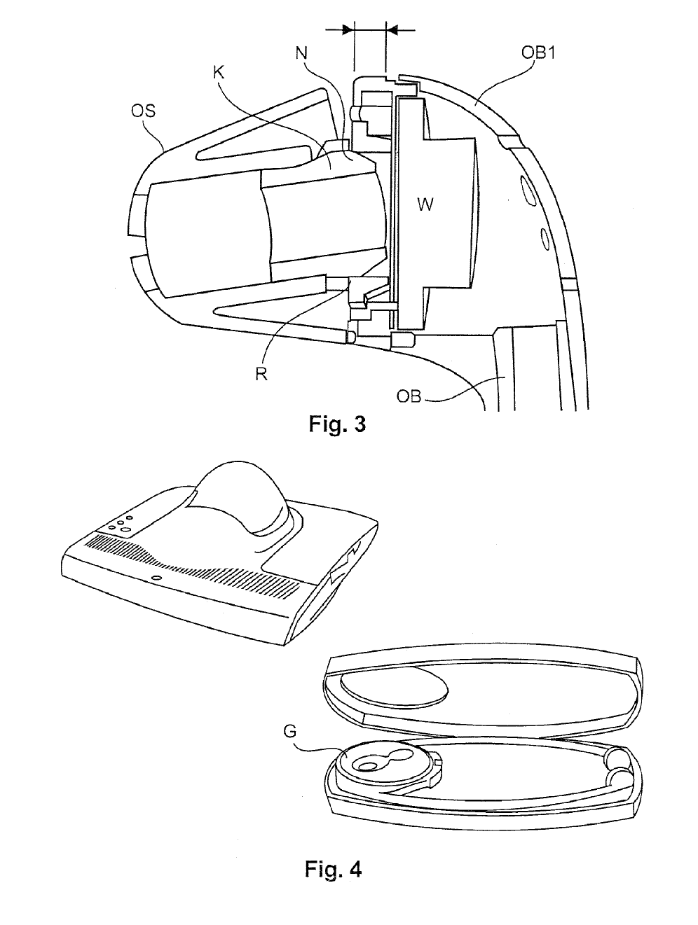

FIG. 3 shows a diagrammatic sectional view of an ear-side end of the earpiece bands according to the first embodiment,

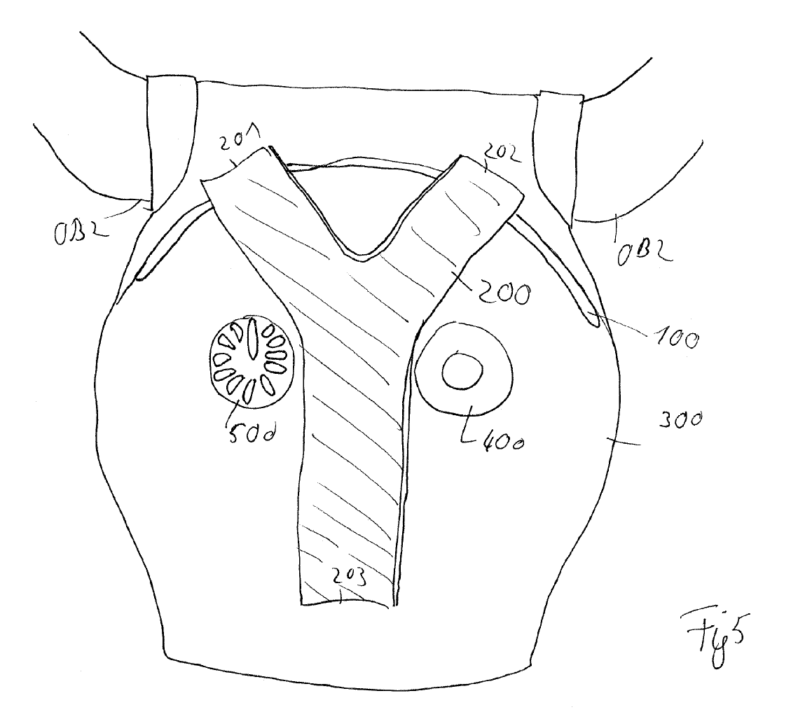

FIG. 4 shows a perspective view of an under-chin band headphone set according to a second embodiment, and

FIG. 5 shows a diagrammatic view of the rear side of a housing of an under-chin band headphone set according to a fourth embodiment.

FIG. 1 shows a diagrammatic view of an under-chin band headphone set according to a first embodiment. The under-chin band headphone set has a housing G for receiving the required electronics, two earpiece bands OB and two earplugs OS at the ear-side end OB1 of the earpiece bands OB, wherein the earplugs OS can be inserted into the outer ear of a user.

FIG. 2 shows a diagrammatic view of an ear-side end of the earpiece band in accordance with the first embodiment. Provided at the ear-side end OB1 of the earpiece band OB are a multiplicity of latching hooks R or projections each having an inwardly facing protrusion, in which a ball joint K is accommodated. The arrangement of the latching hooks R and the ball joint K can ensure that the ball joint is movably secured. The ball joint K or the ball head can have a multiplicity of knobs or holes N so that the latching hooks R or the protrusions of the projections can engage into those knobs or holes N. That can ensure a firm secure fit for the ball joint K, even if the latching hooks R wear out.

FIG. 3 shows a sectional view of the ear-side end OB1 of the earpiece band OB. A ball joint K is secured at the ear-side end OB1 of the earpiece band OB, in a multiplicity of latching hooks R, in such a way that the ball joint K can still be moved. Thus the first end of the ball joint is secured in or at the latching hook (for example by means of the knobs or holes N) and the earplug OS can be pushed on, over the second end of the ball joint. It is therefore possible for the earplug OS to be movably secured to the ear-side end OB1 of the earpiece band OB.

The use of a ball joint K means that the headphone set or the earplugs can be individually adapted to the ear of the user. That can provide a more comfortable fit and improved sound perception.

In accordance with an alternative embodiment to FIG. 2 and FIG. 3 holes or depressions can be arranged at the inside of the latching hooks R and a multiplicity of protrusions can be provided on the ball head of the ball joint so that the protrusions on the ball head can engage into the holes or recesses at the latching hook. That can also ensure a firm reliable fit for the ball joint.

FIG. 4 shows a perspective view of an under-chin band headphone set according to a second embodiment. The under-chin band headphone set according to the second embodiment substantially corresponds to the under-chin band headphone set according to the first embodiment. In this case however the earpiece bands OB are secured rotatably to the housing G. That means that the housing G can be worn during operation, as shown in FIG. 1. For storage the housing can be folded over or rotated relative to the earpiece band OB in such a way that, as shown in FIG. 4, it is laterally enclosed by the two earpiece bands OB.

In accordance with the first and second embodiments the housing G has a wireless receiver, preferably an IR receiver.

In accordance with a third embodiment there is provided an external wireless transmitter which can transmit an audio signal to the receiver. For example various programs or transmission settings can be set at the transmitter S. Thus for example the transmission characteristic of the transmitter can be adjusted. In that case the transmission characteristic can preferably be adapted to the hearing faculty of the user.

The ball joints in accordance with the first and second embodiments are adapted to be removable or interchangeable. Additionally or alternatively thereto the two earpiece bands OB and/or the two earplugs OS can be adapted to be interchangeable. That is particularly advantageous in regard to the hygiene of the under-chin band headphone set.

FIG. 5 shows a diagrammatic view of the rear side of a housing of an under-chin band headphone set in accordance with a fourth embodiment. The rear side 300 of the housing G of an under-chin band headphone set in accordance with the fourth embodiment has for example two operating elements 400, 500, a band 100 and a belt clip 200. The belt clip 200 can be secured to the band 100 or alternatively to the housing. By way of example the belt clip 200 can be of a Y-shaped configuration with three ends 201, 202 and 203, the third end 203 being longer than the first and second ends 201, 202. The first and second ends 201, 202 are securely clipped to the band 100 or secured to the housing so that the third end 203 can be secured for example to a belt. That means that the housing 300 can be worn on a belt.

1. An under-chin band headphone set comprising:
two earpiece bands each having an ear-side end and an end remote from the ear,
two earplugs which are respectively secured to the ear-side end of the two earpiece bands, and
a ball joint at each ear-side end of the earpiece bands, wherein a first end of the ball joint is arranged movably at the ear-side end of the earpiece band and wherein the second end of the ball joint serves to receive the earplug.

2. The under-chin band headphone set as set forth in claim 1 wherein the first end of the ball joint is of a spherical configuration and is secured by means of latching hooks at the ear-side end of the earpiece band.

3. The under-chin band headphone set as set forth in claim 1 wherein provided at a first end of the ball joint is a plurality of holes or recesses which can co-operate with the latching hooks.

4. The under-chin band headphone set as set forth in claim 1 further comprising a housing for receiving at least one electronic unit and having a rear side, wherein a belt clip can be secured to the rear side.

5. The under-chin band headphone set as set forth in claim 1, comprising:
two earpiece bands,
two earplugs which are respectively secured to an ear-side end of the two earpiece bands, and
a housing for receiving at least one electronic unit,
wherein an end, remote from the ear, of the two earpiece bands is respectively arranged rotatably on the housing.
